(19) United States
(12) Patent Application Publication
(10) Pub. No.: US 2007/0186627 A1
(43) Pub. Date: Aug. 16, 2007

(54) High aspect ratio AFM probe and method of making

(76) Inventors: Sungsoo Yi, Sunnyvale, CA (US); Danielle R. Chamberlin, San Mateo, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/351,511

(22) Filed: Feb. 10, 2006

(51) Int. Cl. G01B 5/28

(52) U.S. Cl. 73/105

(57) ABSTRACT

The high aspect ratio atomic force microscope (AFM) probe has a cantilever element with a crystalline growth surface at one end. The AFM probe additionally has a semiconductor nanowire extending substantially orthogonally from the growth surface. The AFM probe is made by covering the cantilever element with sacrificial material, leaving at least part of the growth surface exposed; depositing catalyst metal on the exposed growth surface; removing the sacrificial material leaving the catalyst metal on the growth surface, and growing a semiconductor nanowire extending from the growth surface using the catalyst metal left on the growth surface. The catalyst metal remains at the distal end of the nanowire during the growing.

### RELATED APPLICATIONS

This application is also related to U.S. patent application Ser. No. 11/______ of Ying-Lan Chang et al. entitled Functionalizable Nanowire-Based AFM Probe (Agilent Docket No. 10051419-1) and to U.S. patent application Ser. No. 11/______ of Bo Curry et al. entitled Insertable Nanoscale FET Probe (Agilent Docket No. 10060080-1), both filed on the filing date of this application. The above applications are all assigned to the assignee of this application and the disclosures of the above applications are incorporated into this application by reference.

### BACKGROUND

Atomic force microscopes (AFMs) are widely used to make measurements and perform manipulations at the nanometer scale. A typical AFM has a cantilever AFM probe having a probe tip at its distal end. The probe tip is typically pyramidal or conical in shape and is fabricated from highly-doped single-crystal silicon. The probe tip has a highly reproducible geometry and extremely smooth surfaces because its shape is defined by crystal planes of the silicon.

A probe tip can be characterized by an aspect ratio, which, for the purpose of this disclosure, can be regarded as the length to width ratio of the probe tip. As used in this disclosure, the length of a probe tip is the dimension of the probe tip in a length direction that extends between the base of the probe tip and the tip of the probe tip, and the width of a probe tip is the dimension of the probe tip in a width direction orthogonal to the length direction. The width is typically measured at a point half-way along the length. Conventional AFM probe tips are typically shaped like a pyramid with a polygonal or circular base, and typically have an aspect ratio of the order of unity. However, conventional AFM probe tips with an aspect ratio of the order of ten are commercially available. Conventional probe tips with an aspect ratio greater than ten have been made. However, such probe tips are made by a focused ion beam (FIB) process that damages the probe tip material.

Currently, there is a great interest in understanding the function of living cells and performing single-cell analysis and manipulation including single-cell surgery and controlled drug release. The ability to characterize/manipulate a single cell will greatly increase the understanding of many important biological processes. However, the low aspect ratio and relatively large cross-sectional area of a conventional AFM probe tip makes such probe tip unsuitable for penetrating a single cell, which is typically several micrometers thick.

As an attempt to provide an AFM probe tip having an increased aspect ratio, a semiconductor nanowire has been grown epitaxially on one of the side planes of a conventional probe tip. However, to grow the nanowire requires that a catalyst nanoparticle be selectively placed on one of the side planes, which is extremely difficult. Moreover, the resulting AFM probe has to be mounted in the atomic force microscope using a special mount to compensate for the large tilt angle of the nanowire extending orthogonally from the side plane.

Accordingly, what is needed is an AFM probe tip having a much higher aspect ratio that will enable the biochemical, electrical and mechanical characterization of single cells and that will additionally be useful in other applications requiring an AFM probe tip having a high aspect ratio.

### BRIEF DESCRIPTION OF THE DRAWINGS

FIGS. 1A and 1B are respectively a schematic side view and a schematic bottom view showing part of an example of a high aspect ratio AFM probe in accordance with a first embodiment of the invention.

FIG. 2 is a schematic side view showing part of an example of a high aspect ratio AFM probe in accordance with a second embodiment of the invention.

FIGS. 3A and 3B are respectively a schematic side view and a schematic bottom view showing part of an example of a high aspect ratio AFM probe in accordance with a third embodiment of the invention.

FIG. 4 is a schematic side view showing part of an example of a high aspect ratio AFM probe in accordance with a fourth embodiment of the invention.

FIGS. 5A-5G are schematic side views showing the fabrication of the high aspect ratio AFM probe shown in FIGS. 1A and 1B by an example of a method in accordance with an embodiment of the invention.

FIGS. 6A-6H are schematic side views showing the fabrication of the high aspect ratio AFM probe shown in FIGS. 3A and 3B by an example of a method in accordance with another embodiment of the invention.

### DETAILED DESCRIPTION

In accordance with an embodiment of the invention, a high aspect ratio atomic force microscope (AFM) probe is composed of a cantilever element having a crystalline growth surface at one end, and a semiconductor nanowire extending substantially orthogonally from the growth surface. A growth surface that is closer to the end of the cantilever element than to the middle of the cantilever element will be regarded as being at one end of the cantilever element.

The nanowire constitutes at least part of the probe tip of the AFM probe. The dimensions and aspect ratio of the nanowire depend on the intended application of the AFM probe. With current fabrication technology, the nanowire can have a diameter as small as about 5 nm and a length of the order of micrometers. Thus, the probe tip of the AFM probe can easily have an aspect ratio of the order of 100. A probe tip having such an aspect ratio and a small diameter can penetrate a living cell without causing the cell to rupture. The orthogonal orientation of the nanowire with respect to the cantilever element allows the AFM probe to be mounted conventionally in the host atomic force microscope.

The crystalline growth surface is a defined crystalline plane of the semiconductor material underlying the growth surface. In typical embodiments, the growth surface is the (111) crystalline plane of the underlying semiconductor material. A silicon nanowire grown on a silicon (111) crystalline plane will grow epitaxially, i.e., the crystallographic orientation of the growth surface will be imposed on the nanowire, and the nanowire will grow in a direction substantially orthogonal to the growth surface. Typically, the nanowire will grow in a direction within ±10° of the orthogonal direction. Hence, a nanowire grown on a growth surface disposed parallel to the cantilever element will extend substantially orthogonally to the growth surface, and, hence, will additionally extend substantially orthogonally to the cantilever element.

In other embodiments, the growth surface is a (100) crystalline plane or a (110) crystalline plane of the underlying semiconductor material. It is typically more difficult to grow a silicon nanowire with good material quality on a silicon growth surface that is the (100) crystalline plane or the (110) crystalline plane than on a silicon growth surface that is the (111) crystalline plane. However, the (100) crystalline plane and/or the (110) crystalline plane may give better material quality than the (111) crystalline plane in a nanowire grown from a semiconductor material other than silicon.

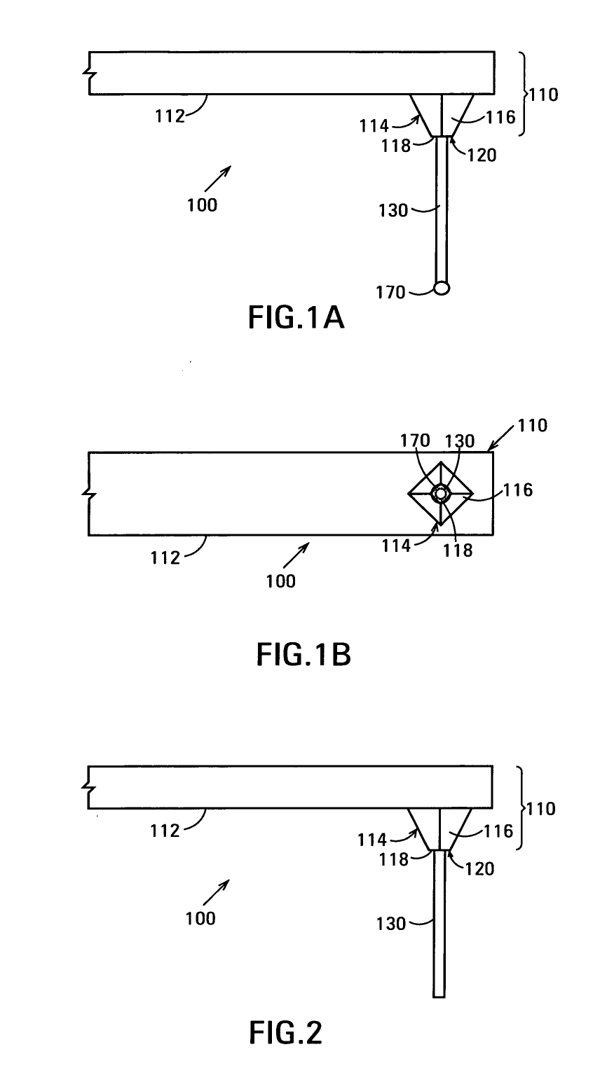

FIGS. 1A and 1B are respectively a schematic side view and a schematic bottom view showing part of an example of a high aspect ratio AFM probe 100 in accordance with a first embodiment of the invention. AFM probe 100 is composed of a cantilever element 110 having a crystalline growth surface 120 at one end, and a semiconductor nanowire 130 extending substantially orthogonally from growth surface 120. In AFM probe 100, cantilever element 110 is composed of a cantilever arm 112 and a frusto-pyramidal probe tip base 114 located at one end of cantilever arm 112. As used in this disclosure, the term frusto-pyramidal encompasses fusto-conical, a cone being a pyramid having a base with an infinite number of sides. A probe tip base that is closer to one end of cantilever arm 112 than to the middle of cantilever arm 112 will be regarded as being at one end of cantilever arm 112. FIGS. 1A and 1B show only a portion of cantilever element 110 and cantilever arm 112 adjacent probe tip base 114 to enable probe tip base 114 and nanowire 130 to be shown in more detail. Cantilever arm 112 is attached to the host atomic force microscope (AFM)(not shown) at or adjacent its other end (not shown).

Probe tip base 114 has crystalline side facets, an exemplary one of which is shown at 116, and, at its distal end, remote from cantilever arm 112, a crystalline end facet 118. In this first embodiment, end facet 118 provides growth surface 120, i.e., nanowire 130 extends from end facet 118. End facet 118 is substantially parallel to cantilever arm 112, i.e., end facet 118 is parallel to cantilever arm 112 typically within ±10°. End facet 118 is typically less than about 0.01 μm² in area.

In a typical embodiment, a monolithic, a single-crystal semiconductor AFM probe having a frusto-pyramidal single-crystal silicon probe tip is used as cantilever element 110. Such monolithic, single-crystal semiconductor AFM probes are sold by NanoWorld AG of Neuchâtel, Switzerland. In such AFM probe, the cantilever arm and probe tip are respective portions of a single piece of single-crystal silicon. In embodiments in which cantilever element 110 is electrically conducting, the single-crystal silicon is doped with a suitable dopant, such as arsenic. In other embodiments, cantilever arm 112 and probe tip base 114 are separate components, and the material of cantilever arm 112 need not be a semiconductor.

Nanowire 130 extends substantially orthogonally from growth surface 120 provided by the crystalline end facet 118 at the distal end of probe tip base 114, i.e., nanowire 130 extends in a direction typically within ±10° of the direction orthogonal to end facet 118. The material of nanowire 130 is a single-crystal semiconductor material, such as a single-crystal group IV semiconductor, e.g., silicon (Si); a single-crystal group III-V semiconductor, e.g., gallium arsenide (GaAs); or a single-crystal group II-VI semiconductor, such as zinc oxide (ZnO). In embodiments in which nanowire 130 is electrically conducting, the single-crystal semiconductor material of the nanowire is doped with a suitable dopant.

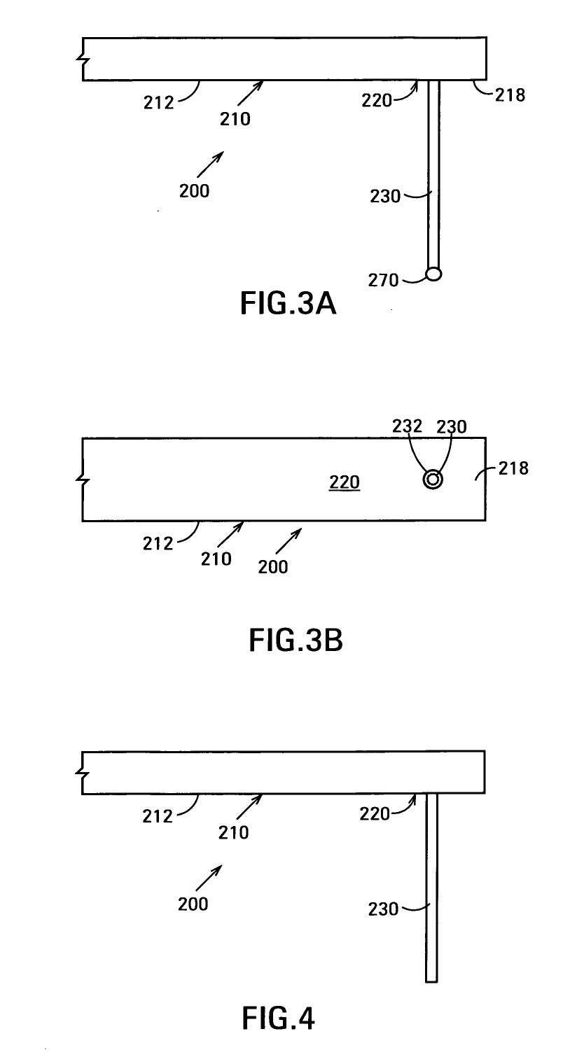

In the example shown in FIGS. 1A and 1B, nanowire 130 has a catalyst nanoparticle 170 at its distal end, remote from probe tip base 114. The material of catalyst nanoparticle 170 is an alloy of the semiconductor material of nanowire 130 and a catalyst metal. Catalyst nanoparticle 170 provides AFM probe 100 with additional functionality in some applications. Other embodiments, such as that shown in FIG. 2, have no catalyst nanoparticle at the distal end of nanowire 130.

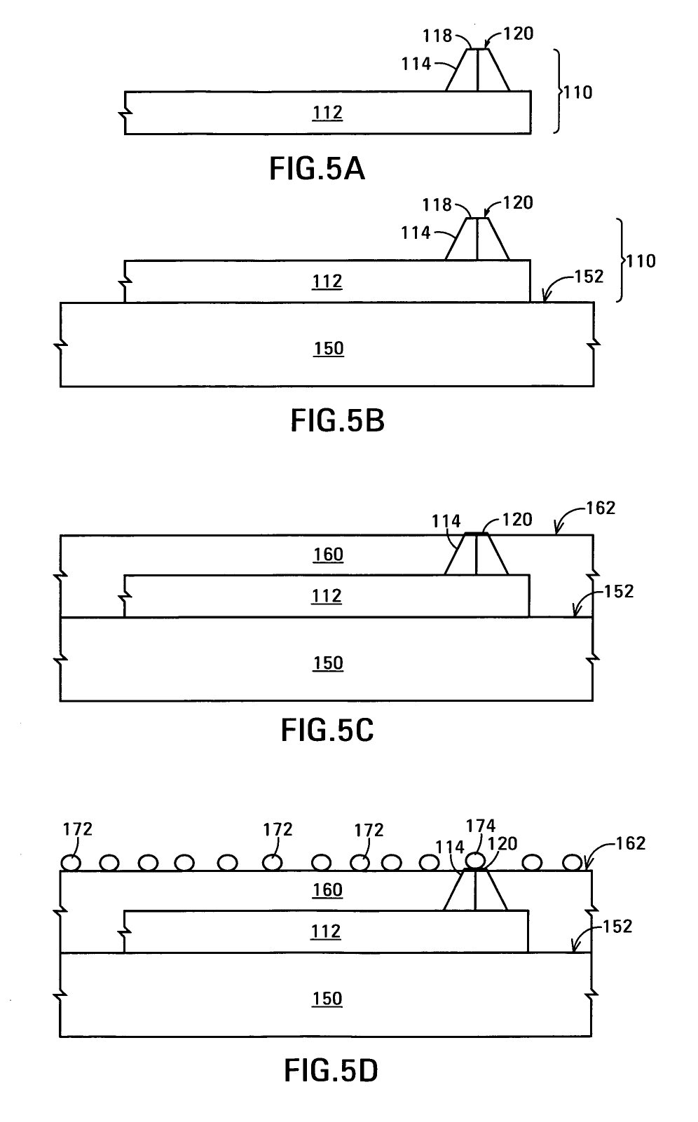

FIGS. 3A and 3B are respectively a schematic side view and a schematic bottom view showing part of a high aspect ratio AFM probe 200 in accordance with a third embodiment of the invention. AFM probe 200 is composed of a cantilever element 210 having a crystalline growth surface 220 at one end, and a semiconductor nanowire 230 extending substantially orthogonally from growth surface 220. In this third embodiment of an AFM probe in accordance with the invention, a cantilever arm 212 is used as cantilever element 210. FIGS. 3A and 3B show only a portion of cantilever element 210 and cantilever arm 212 adjacent nanowire 230 to enable nanowire 230 to be shown in more detail. Cantilever arm 212 is attached to the host AFM (not shown) at or adjacent its other end (not shown).

In the example shown, cantilever arm 212 is an elongate piece of single-crystal semiconductor material in which one of the crystalline planes of the semiconductor material coincides with a major external surface 218 of the cantilever arm. In this third embodiment, the external surface 218 of cantilever arm 212 that coincides with one of the crystalline planes of the semiconductor material of cantilever arm 212 provides growth surface 220, i.e., nanowire 230 extends from external surface 218. In an embodiment, external surface 218 is substantially parallel to the longitudinal axis of cantilever arm 212, i.e., external surface 218 is parallel to the longitudinal axis of cantilever arm 212 typically within ±10°.

In a typical embodiment, a tipless, monolithic, single-crystal semiconductor AFM probe is used as cantilever element 210. Such tipless, monolithic, single-crystal semiconductor AFM probes are sold by NanoWorld AG of Neuchâtel, Switzerland. Such tipless AFM probe is a single piece of single-crystal silicon. In embodiments in which cantilever element is electrically conducting, the single-crystal silicon is doped with a suitable dopant, such as arsenic. In other embodiments, not shown, the material of the cantilever arm is not a semiconductor. In such embodiments, the cantilever arm has a layer of crystalline semiconductor material on at least part of a major external surface at one end of the cantilever arm. The exposed surface of the semiconductor material provides growth surface 220.

Nanowire 230 extends substantially orthogonally from growth surface 220 provided by the crystalline external surface 218 of cantilever arm 212, i.e., nanowire 230 extends in a direction typically within ±10° of the direction orthogonal to external surface 218. The material of nanowire 230 is a single-crystal semiconductor material, such as a single-crystal group IV semiconductor, e.g., silicon (Si); a single-crystal group III-V semiconductor, e.g., gallium arsenide (GaAs); or a single-crystal group II-VI semiconductor, such as zinc oxide (ZnO). In embodiments in which nanowire 230 is electrically conducting, the single-crystal semiconductor material is doped with a suitable dopant.

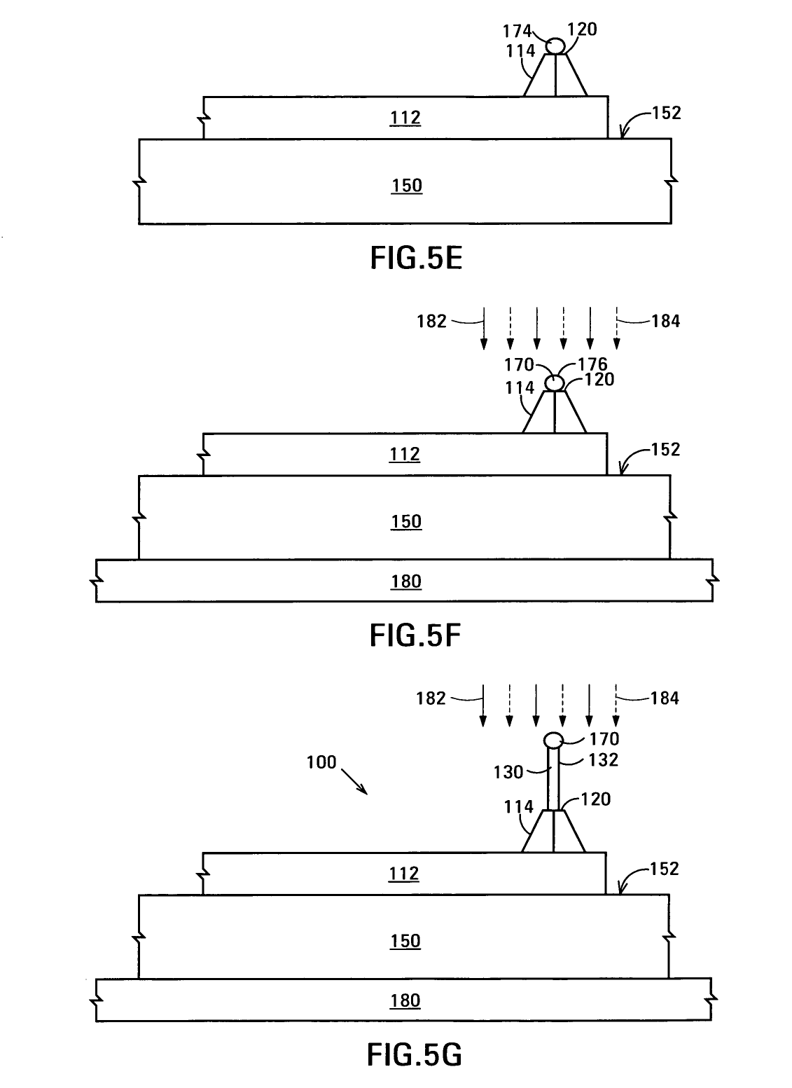

In the example shown in FIGS. 3A and 3B, nanowire 230 has a catalyst nanoparticle 270 at its distal end, remote from cantilever arm 212. The material of catalyst nanoparticle 270 is an alloy of the semiconductor material of nanowire 230 and a catalyst metal. Catalyst nanoparticle 270 provides AFM probe 200 with additional functionality in some applications. Other embodiments, such as that shown in FIG. 4, have no catalyst nanoparticle at the distal end of nanowire 230.

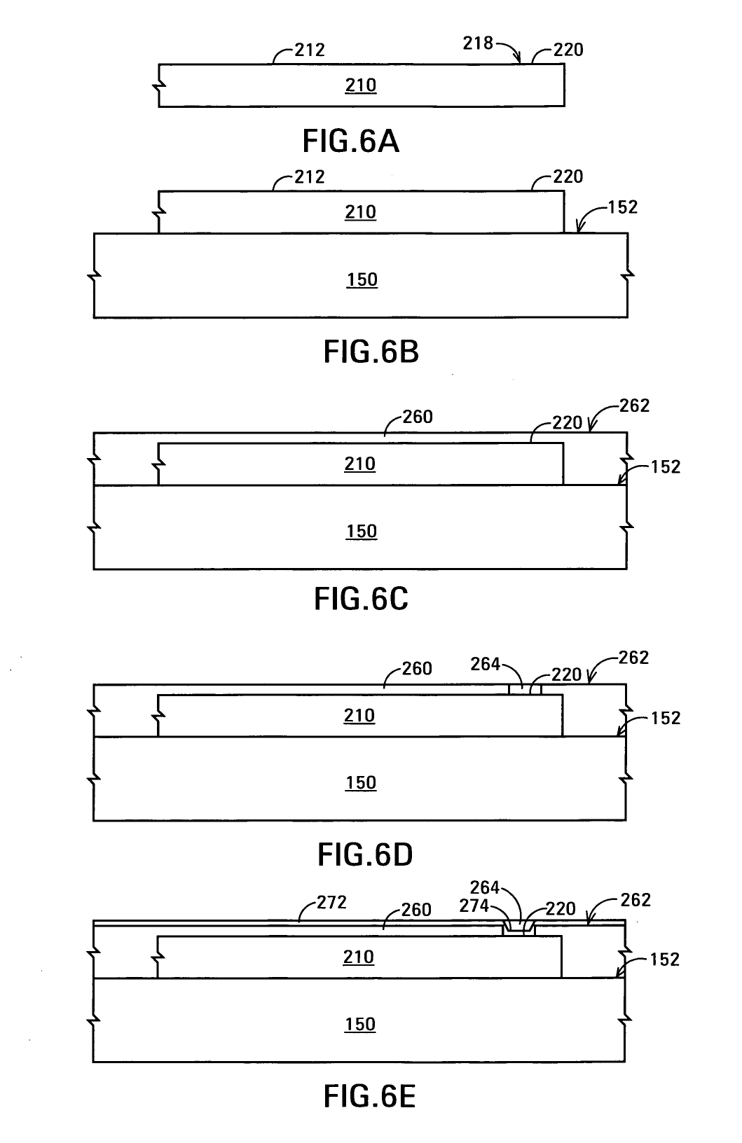

An example of a method in accordance with an embodiment of the invention for making high aspect ratio AFM probe 100 described above with reference to FIGS. 1A and 1B will be described next with reference to FIGS. 5A-5G.

A cantilever element having a crystalline growth surface at one end is provided. FIG. 5A shows an embodiment of cantilever element 110 composed of a cantilever arm 112 having a frusto-pyramidal probe tip base 114 at one end. Frusto-pyramidal probe tip base 114 has a crystalline end facet 118 at its distal end, remote from cantilever arm 112. Crystalline end facet 118 provides the crystalline growth surface 120 of cantilever element 110. FIG. 5A shows only a portion of cantilever arm 112 adjacent probe tip base 114 to enable probe tip base 114 to be shown in more detail.

As noted above, a monolithic single-crystal AFM probe with a frusto-pyramidal probe tip is typically used as the cantilever element 110 that constitutes part of each AFM probe 100 in accordance with the first embodiment of the invention. Such conventional AFM probes can be commercially supplied mounted in the wafer of single-crystal silicon in which they are defined. Thus, cantilever elements including cantilever element 110 can be commercially supplied mounted in the wafer of single-crystal silicon (not shown) in which they are defined. This wafer will be referred to as a probe wafer. The cantilever elements are joined to the probe wafer by narrow beams that extend from each cantilever element to the remainder of the probe wafer. Many AFM probes similar to AFM probe 100 are fabricated at a time by subjecting the probe wafer in which the cantilever elements are defined to the processing to be described below. Such wafer-scale fabrication makes the AFM probes inexpensive to fabricate. Alternatively, the processing described herein with reference to FIGS. 5A-5G may be adapted to make small batches of AFM probes similar to AFM probe 100 from the cantilever elements supplied mounted in a portion of a full probe wafer, or to make individual instances of AFM probe 100.

FIGS. 5A-5G illustrate, and the following description describes, the fabrication of AFM probe 100 in accordance with the invention on a portion of the probe wafer constituting one cantilever element. As AFM probe 100 is fabricated, AFM probes similar to AFM probe 100 are fabricated on the remaining cantilever elements in the probe wafer.

In the example shown, cantilever arm 112 and probe tip base 114 are respective portions of a single piece of single-crystal silicon. The end facet 118 of probe tip base 114 is substantially parallel to cantilever arm 112, as defined above, and is typically the (111) crystalline plane of the silicon of the probe tip base. A group IV or group III-V semiconductor nanowire grown on the (111) crystalline plane of silicon will grow epitaxially, i.e., the crystallographic orientation of the semiconductor material at the end facet of the probe tip base imposes a specific crystallographic orientation on the nanowire, and the nanowire will grow in a direction substantially orthogonal to the crystalline plane. Hence, nanowire 130 that later will be grown on the growth surface 120 of cantilever element 110 will extend substantially orthogonally from the growth surface. Probe tip base 114 may alternatively be a suitably-shaped piece of single-crystal silicon mounted on cantilever arm 112. In such an embodiment, the end facet 118 of probe tip base 114 that provides growth surface 120 is the (111) crystalline plane of the silicon of the probe tip base so that the growth direction of nanowire 130 is defined as described above. In other embodiments, end facet 118 is a (100) or a (110) crystalline plane, although, as noted above, it is more difficult to grow a silicon nanowire with good material quality on such crystalline planes than on the (111) crystalline plane.

In one specific example, cantilever arm 112 and probe tip base 114 are the cantilever arm and probe tip, respectively, of a monolithic single-crystal AFM probe having a frusto-pyramidal single-crystal silicon probe tip sold by NanoWorld AG of Neuchâtel, Switzerland.

The probe wafer in which the cantilever elements including cantilever element 110 are supplied typically has apertures extending between its major surfaces. The apertures make the probe wafer incompatible with the vacuum chucks used in some of the processes described below. To remedy this incompatibility, the probe wafer is temporarily mounted on the major surface 152 of a handle wafer 150 with probe tip base 114 facing away from major surface 152, as shown in FIG. 5B. Handle wafer 150 is a wafer of conventional thickness, i.e., about 0.5 mm. In the following description, processes described as being applied to the handle wafer are applied to the handle wafer and all elements currently supported by the handle wafer. Additionally, operations described as being applied to the probe wafer are applied to the probe wafer, the cantilever elements defined in the probe wafer and all layers currently supported by the probe wafer.

In an embodiment, handle wafer 150 is a wafer of single-crystal silicon and the probe wafer is temporarily attached to the handle wafer using clips (not shown). Alternative handle wafer materials include ceramics, sapphire and other suitable materials. In other embodiments, cantilever elements similar to cantilever element 110 are supplied temporarily mounted on a handle wafer.

The cantilever element is covered with sacrificial material leaving at least part of the growth surface exposed. FIG. 5C shows a sacrificial layer 160 of sacrificial material covering cantilever element 110, including cantilever arm 112 and probe tip base 114, but leaving growth surface 120 exposed. The thickness of sacrificial layer 160 is nominally slightly less than the distance from handle wafer surface 152 to growth surface 120 so that growth surface 120 projects from the surface 162 of sacrificial layer 160. Such a thickness of the sacrificial layer leaves growth surface 120 exposed. Directional reactive ion etching or another etching technique can be used to remove any sacrificial material from growth surface 120.

In an embodiment, the sacrificial material of sacrificial layer 160 was polymethylmeth-acrylate (PMMA). The PMMA sacrificial material was deposited on the probe wafer to cover the probe wafer, cantilever element 110, including cantilever arm 112 and probe tip base 114, by spin coating. The viscosity of the sacrificial material and the spin speed were set to obtain a nominal layer thickness about 100 nm less than the distance from handle wafer surface 152 to growth surface 120 so that growth surface 120 is left exposed.

Photoresist spun onto the probe wafer may be used instead of PMMA as the sacrificial material. Other materials that are compatible with the subsequently-performed processing and that can be applied in a manner that causes surface 162 to be a planar surface are known in the art and may alternatively be used. As a further alternative, a layer of a material that covers underlying elements conformally may be deposited on the probe wafer to cover cantilever element 110, including cantilever arm 112, probe tip base 114 and growth surface 120. The surface of the layer of conformally-covering material is then subject to chemical mechanical polishing (CMP) to expose growth surface 120. An example of a conformally-covering material is silicon dioxide (SiO₂) deposited by chemical vapor deposition (CVD).

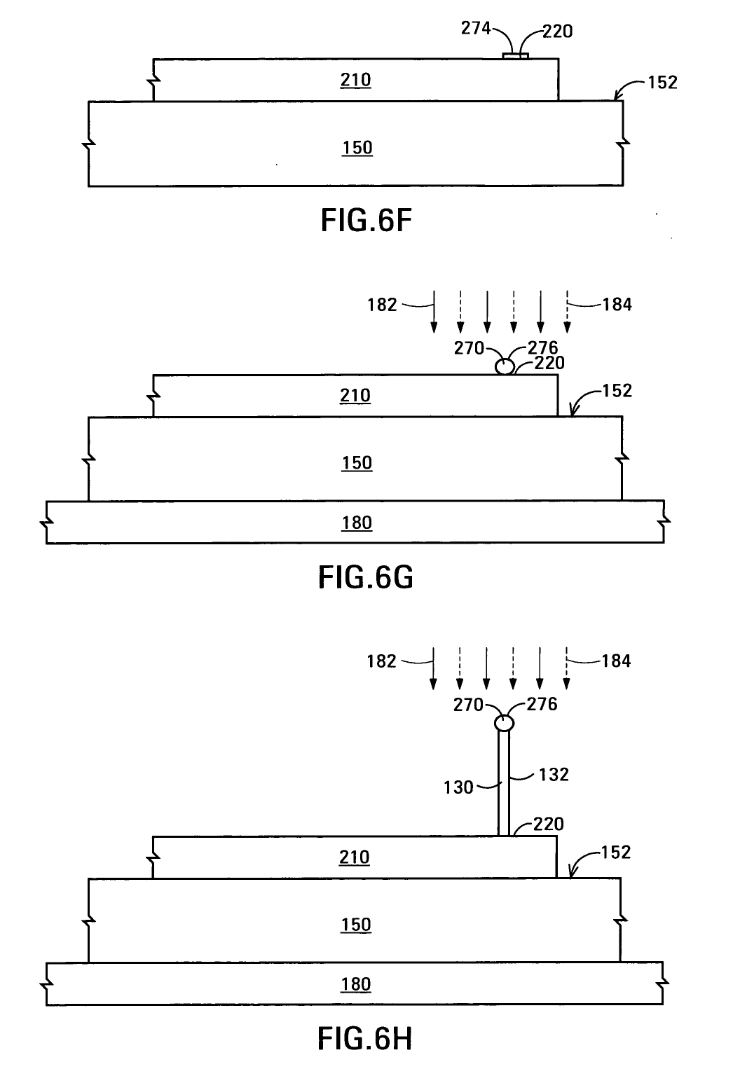

In a further alternative, a layer of sacrificial material is deposited on the probe wafer as sacrificial layer 160. The sacrificial material may be one that causes surface 162 to be a planar surface, or one that conformally covers underlying elements. Sacrificial layer 160 covers cantilever element 110, including cantilever arm 112, probe tip base 114 and growth surface 120. A portion of sacrificial layer 160 overlying growth surface 120 is then selectively removed to expose at least part of growth surface 120. The portion of the sacrificial layer 160 subject to removal is defined by electron beam lithography. Other lithographic techniques such photolithography and nanoimprint lithography are known in the art and may alternatively be used. The portion of the sacrificial layer may be removed using a process similar to that described below with reference to FIG. 6D. In one embodiment, sacrificial layer 160 is a layer of photoresist.

The processing described above with reference to FIG. 5C typically leaves growth surface 120 covered by a thin layer of native silicon dioxide (SiO₂) that, if left in place, would hinder the epitaxial growth of nanowire 130 (FIG. 1A) on growth surface 120. Accordingly, such native oxide layer is removed by subjecting growth surface 120 to an etchant that dissolves silicon dioxide.

In an embodiment, the layer of native silicon dioxide was removed from growth surface 120 by subjecting the probe wafer to a wet etch process using dilute hydrofluoric acid (HF) as the etchant. In another embodiment, the layer of native silicon dioxide was removed by subjecting the probe wafer to a dry etch process using HF vapor as the etchant.

Catalyst metal suitable for catalyzing a vapor-liquid-solid nanostructure growth process is then deposited on the growth surface. FIG. 5D shows nanoparticles of catalyst metal deposited on the surface 162 of sacrificial layer 160 and on growth surface 120 at the distal end of probe tip base 114, remote from cantilever arm 112. The fraction of the area of the surface 162 of sacrificial layer 160 occupied by growth surface 120 is very small. The nanoparticles of catalyst metal are applied at such an area density that, on average, more than zero but no more than one nanoparticle 174 is located on growth surface 120. Examples of the nanoparticles of catalyst metal located on the surface 162 of sacrificial layer 160 are shown at 172.

The catalyst metal constituting nanoparticles 172 and 174 is one capable of catalytically decomposing a gaseous precursor to release a respective constituent element of the semiconductor material of which nanowire 130 (FIG. 1A) will be grown. Typical catalyst nanoparticles are nanoparticles of gold (Au), nickel (Ni), palladium (Pd) or titanium (Ti).

The size of nanoparticle 174 determines the diameter of nanowire 130 (FIG. 1A). In an embodiment, the catalyst nanoparticles had an average diameter in the range from about 5 nm to about 20 nm.

In an embodiment, a solution containing colloidal nanoparticles of catalyst metal is spun onto the surface 162 of sacrificial layer 160. Handle wafer 150 is then gently heated to evaporate the liquid component of the colloidal solution. This leaves nanoparticle 174 located on growth surface 120 and nanoparticles 172 distributed over the surface 162 of sacrificial layer 160. In another embodiment, an aqueous solution of colloidal nanoparticles of catalyst metal is mixed with methanol (CH₃OH) and the resulting mixture is dropped onto the surface 162 of sacrificial layer 160. The mixture rapidly spreads over surface 162 and growth surface 120. The handle wafer is then gently heated to evaporate the liquid component of the dilute colloidal solution. This leaves nanoparticle 174 located on growth surface 120 and nanoparticles 172 distributed over surface 162 of sacrificial layer 160.

In another embodiment, nanoparticles 174 and 172 of catalyst metal are deposited using electron beam evaporation.

In yet another embodiment, galvanic displacement is used to deposit a nanoparticle of gold selectively on growth surface 120. In this, an electrical connection is made to probe tip base 114 via cantilever arm 112 and the probe wafer, and the probe wafer is placed in a solution of gold potassium cyanide (AuK(CN)₂) or another suitable electrolyte. A suitable anode is also placed in the electrolyte and a current is passed through the electrolyte between the anode and the probe wafer. The silicon of growth surface 120 acts as a reducing agent and gold is deposited on the growth surface through a redox mechanism.

The sacrificial material is then removed leaving the catalyst metal deposited on the growth surface. FIG. 5E shows cantilever element 110 after sacrificial layer 160 (FIG. 5D) has been removed. Removing sacrificial layer 160 removes all of the nanoparticles 172 of catalyst metal located on the surface 162 of the sacrificial layer, but leaves nanoparticle 174 of catalyst metal located on growth surface 120.

In an embodiment, sacrificial layer 160 of PMMA is removed by a lift-off process in which the probe wafer is immersed in acetone ((CH₃)₂CO). A photoresist sacrificial layer 160 is removed by a lift-off process in which the probe wafer is immersed in the appropriate developer for the photoresist. A silicon dioxide sacrificial layer 160 is removed by a wet etch process in which dilute hydrofluoric acid (HF) is used as the etchant.

A semiconductor nanowire is then grown extending from the growth surface using the catalyst metal remaining on the growth surface as catalyst. FIGS. 5F and 5G show nanowire 130 being grown extending from growth surface 120 using nanoparticle 174 (FIG. 5E) of catalyst metal remaining on the growth surface as catalyst in a vapor-liquid-solid growth process.

In an embodiment, handle wafer 150 is placed on the susceptor 180 of a chemical vapor deposition (CVD) reactor (not shown) and the susceptor and, hence, the handle wafer and the probe wafer, are heated to a deposition temperature near the eutectic point of an alloy between the catalyst metal of nanoparticle 174 and the semiconductor material from which nanowire 130 will be grown. In an embodiment in which the catalyst metal of nanoparticle 174 was gold and the semiconductor material from which nanowire 130 is grown was silicon, the susceptor was heated to a growth temperature of about 450° C.

A growth pressure is established inside the CVD reactor and a gaseous precursor mixture is passed over the probe wafer. In FIG. 5F, the gaseous precursor mixture is represented by solid arrows, an exemplary one of which is shown at 182. Reference numeral 182 will be used to refer to the gaseous precursor mixture. Gaseous precursor mixture 182 is composed of a substantially inert carrier gas and one or more precursors in a gaseous state. The precursors include a precursor for each constituent element of the bulk semiconductor material of nanowire 130 and, optionally, a precursor for each dopant (typically only one dopant) for the semiconductor material of nanowire 130. In an embodiment in which the bulk semiconductor material of nanowire 130 has a single constituent element, such as silicon, gaseous precursor mixture 182 is composed of the carrier gas, a precursor that comprises the single constituent element and, optionally, a precursor for the element with which the bulk semiconductor material is doped. Exemplary precursors for silicon are silane (SiH₄) and disilane (Si₂H₆). An exemplary precursor for arsenic, a typical n-type dopant for silicon, is arsine (AsH₃). In an embodiment in which the bulk semiconductor material of nanowire 130 is a compound semiconductor, i.e., a semiconductor such as gallium arsenide (GaAs) having more than one constituent element, the gaseous precursor mixture is composed of the carrier gas, one or more precursors that collectively comprise the constituent elements of the compound semiconductor, and, optionally, a precursor for the element with the bulk semiconductor material is doped. Typically, such gaseous precursor mixture has a different precursor for each constituent element of the compound semiconductor material and the optional dopant. In an example in which the material of nanowire 130 was gallium arsenide, the precursors were trimethyl gallium (TMG) for gallium, arsine (AsH₃) for arsenic, and, optionally, silane (SiH₄) for silicon, a typical n-type dopant for gallium arsenide.

Further details of the growth of nanowire 130 will now be described with reference to an example in which the semiconductor material of nanowire 130 has a single constituent element, namely, silicon. The description below can readily be applied to the growth of a nanowire whose semiconductor material is a compound semiconductor. Moreover, the precursor and adatoms of the dopant will not be mentioned in the following description.

Molecules of the precursor in gaseous precursor mixture 182 that contact nanoparticle 174 of catalyst metal are catalytically decomposed by the catalyst metal. Adatoms of the constituent element resulting from the decomposition of the precursor are deposited on the surface 176 of nanoparticle 174. The deposited adatoms mix with the catalyst metal to form an alloy, which has a lower melting point than the original catalyst metal of nanoparticle 174. The alloy melts to form catalyst nanoparticle 170, which is in a molten state.

Catalyst nanoparticle 170 is capable of catalytically decomposing the precursors in precursor mixture 182. Consequently, additional adatoms of the constituent element(s) are deposited on the surface 176 of catalyst nanoparticle 170 and increase the fraction of the constituent element in the alloy until the alloy becomes saturated with the constituent element. Then, further adatoms of the constituent element cause a corresponding number of atoms of the constituent element to be released from catalyst nanoparticle 170 at its surface adjacent growth surface 120. The released atoms grow epitaxially on the growth surface to form a solid nanowire 130 that extends orthogonally from the growth surface.

Further deposition of adatoms of the constituent element on molten catalyst nanoparticle 170 cause the release of additional atoms of the constituent element from the molten catalyst nanoparticle and an increase in the length of nanowire 130, as shown in FIG. 5G. Molten catalyst nanoparticle 170 remains at the distal end of nanowire 130, remote from growth surface 120, throughout the nanowire growth process. The process of passing gaseous precursor mixture 182 over the probe wafer is continued until nanowire 130 reaches its design length.

Nanowire 130 has a lateral surface 132 that, during the growth of the nanowire, is also exposed to gaseous precursor mixture 182. Some of the molecules of the precursor in gaseous precursor mixture 182 contact lateral surface 132 and decompose non-catalytically to deposit respective adatoms of the constituent element on lateral surface 132. Such adatoms accumulate on lateral surface 132. The rate of lengthways growth of nanowire 130 is substantially constant, so the time that an annular segment of lateral surface 132 is exposed to gaseous precursor mixture 182 is inversely proportional to the distance of the annular segment from end facet 118. Consequently, adatoms accumulated on lateral surface 132 cause the cross-sectional area of nanowire 130 to increase with increasing distance from catalyst nanoparticle 170. As a result, nanowire 130 has a tapered shape, rather than the non-tapered shape shown. If the taper is not severe, such a tapered shape is acceptable, and may be desirable, in some applications.

In applications in which the non-tapered shape of nanowire 130 shown in FIGS. 1A, 2, 3A and 4 is desirable, i.e., in which nanowire 130 has a uniform cross-sectional area along its length, a gaseous etchant is passed over the probe wafer in addition to precursor mixture 182. The gaseous etchant is represented in FIGS. 5F and 5G by broken arrows 184. Reference numeral 184 will be used to refer to the gaseous etchant. Gaseous etchant 184 removes the adatoms of the constituent element from lateral surface 132 by forming a volatile compound with the adatoms of the constituent element deposited on lateral surface 132. The volatile compound is volatile at the growth temperature and growth pressure established inside the CVD reactor. As the carrier gas that forms part of precursor mixture 182 passes over the probe wafer, it carries the molecules of the volatile compound away from lateral surface 132 into the exhaust system of the CVD reactor. The etch rate of the adatoms deposited on lateral surface 132 is several orders of magnitude greater than that of the crystalline material of the lateral surface itself. As a result, the gaseous etchant removes the adatoms but has a negligible etching effect on lateral surface 132.

In an embodiment, gaseous etchant 184 was a halogenated hydrocarbon, such as halogenated methane. In one example, the halogenated methane was carbon tetrabromide (CBr₄). In another example, the halogenated methane was carbon tetrachloride (CCl₄). Not all the hydrogen atoms of the halogenated hydrocarbon need be substituted. Moreover, ones of the hydrogen atoms may be replaced by different halogens. In another embodiment, gaseous etchant 184 was a hydrogen halide (HX), where X=fluorine (F), chlorine (Cl), bromine (Br) or iodine (I).

In another embodiment, gaseous etchant 184 is provided by using a halogen-containing precursor as the precursor for at least one of the constituent elements. The halogen-containing precursor forms part of gaseous precursor mixture 182 passed over the probe wafer. The halogen-containing precursor is catalytically decomposed at the surface 176 of nanoparticle 170. Adatoms of the constituent element are deposited on surface 176 and the halogen is released into the gaseous precursor mixture. The carrier gas carries the halogen released from the halogen-containing precursor to the lateral surface 132 of nanowire 130 as gaseous etchant 184. Additional halogen may be released by non-catalytic decomposition of the halogen-containing precursor at the lateral surface. At lateral surface 132, the halogen combines with adatoms newly-deposited on the lateral surface to form a volatile compound and the carrier gas carries the volatile compound away from the lateral surface.

To make the embodiment shown in FIG. 2, after growth of nanowire 130 is complete, an etch process using an etchant that is selective between the semiconductor material of nanowire 130 and the alloy material of catalyst nanoparticle 170 is performed to remove nanoparticle 170 from the end of nanowire 130.

The probe wafer in which the AFM probes including AFM probe 100 have been fabricated is then detached from handle wafer 150. AFM probe 100 is then broken out from the probe wafer and is mounted in a host atomic force microscope.

In an embodiment, the probe wafer including AFM probe 100 is detached from handle wafer 150 by removing the clips (not shown) holding the wafers together.

In the above description, the probe wafer is detached from handle wafer 150 after nanowire 130 has been grown. Alternatively, the probe wafer can be detached from the handle wafer after sacrificial layer 160 has been removed but before nanowire 130 is grown. In this case, the probe wafer is placed directly on the susceptor 180 (FIG. 5F) of the CVD growth chamber.

In embodiments of the above method in which the probe wafer lacks apertures extending between its major surfaces, the handle wafer referred to above is unnecessary.

In embodiments of the above method in which the cantilever elements do not constitute part of a probe wafer, such cantilever elements may be mounted on the handle wafer (FIG. 5B) using double-sided adhesive tape. In an example, the double-sided adhesive tape was based on a polyimide film. After the sacrificial layer has been removed, leaving the catalyst metal on the growth surface (FIG. 5E), the cantilever elements are removed from the handle wafer by carefully pulling them off the adhesive tape. The cantilever elements are then placed in appropriately-shaped recesses defined in the susceptor of the CVD growth chamber for the nanowire growth process described above with reference to FIGS. 5F and 5G. Alternatively, the cantilever elements may be mounted on the surface of an uncontoured susceptor using small clips.

An example of a method in accordance with an embodiment of the invention for making high aspect ratio AFM probe 200 described above with reference to FIGS. 3A and 3B will be described next with reference to FIGS. 6A-6H.

A cantilever element is provided. The cantilever element has a crystalline growth surface at one end. FIG. 6A shows an embodiment of cantilever element 210 composed of a cantilever arm 212. In the example shown, cantilever arm 212 is an elongate piece of single-crystal semiconductor material in which one of the crystalline planes of the semiconductor material coincides with major external surface 218 of the cantilever arm. The external surface 218 of cantilever arm 212 that coincides with one of the crystalline planes of the semiconductor material of cantilever arm 212 provides growth surface 220. FIGS. 6A-6H show only a portion of cantilever arm 212 adjacent one of its end to enable nanowire 230 to be shown in more detail.

As noted above, a tipless monolithic single-crystal AFM probe is typically used as the cantilever element 210 that constitutes part of each AFM probe 200 in accordance with the third embodiment of the invention. Such conventional tipless AFM probes can be commercially supplied mounted in the wafer of single-crystal silicon in which they are defined. Thus, cantilever elements including cantilever element 210 can be commercially supplied mounted in the wafer of single-crystal silicon (not shown) in which they are defined. This wafer will be referred to as a probe wafer. The cantilever elements are joined to the probe wafer by narrow beams that extend from each cantilever element to the remainder of the probe wafer. Many AFM probes similar to AFM probe 200 are fabricated at a time by subjecting a probe wafer in which cantilever elements are defined to the processing to be described below. Such wafer-scale fabrication makes the AFM probes inexpensive to fabricate. Alternatively, the processing described herein with reference to FIGS. 6A-6H may be adapted to make small batches of AFM probes similar to AFM probe 200 from the cantilever elements supplied mounted in a portion of a full probe wafer, or to make individual instances of AFM probe 200. FIGS. 6A-6H illustrate, and the following description describes, the fabrication of AFM probe 200 in accordance with the invention on a portion of the probe wafer (not shown) constituting one cantilever element. As AFM probe 200 is fabricated, AFM probes similar to AFM probe are fabricated on the remaining cantilever elements in the probe wafer.

In the example shown, cantilever arm 212 is a single piece of single-crystal silicon. External surface 218 is substantially parallel to cantilever arm 212, as defined above, and is typically the (111) crystalline plane of the silicon of the cantilever arm. A group IV or group III-V semiconductor nanowire grown on the (111) crystalline plane of silicon will grow epitaxially, i.e., the crystallographic orientation of the semiconductor material at the external surface will be imposed on the nanowire, and the nanowire will grow in a direction orthogonal to the crystalline plane. Hence, the nanowire that later will be grown on the growth surface 220 of cantilever element 210 will extend orthogonally from the growth surface, and, hence, will additional extend orthogonally to cantilever arm 212. In other embodiments, external surface 218 is a (100) or a (110) crystalline plane, although, as noted above, it is more difficult to grow a silicon nanowire with good material quality on such crystalline planes than on the (111) crystalline plane.

In one specific example, cantilever arm 212 is a tipless monolithic single-crystal AFM probe sold by NanoWorld AG of Neuchâtel, Switzerland.

The probe wafer in which the cantilever elements including cantilever element 210 are supplied typically has apertures extending between its major surfaces. To make the probe wafer compatible with the vacuum chucks used in some of the processes described below, the probe wafer is temporarily mounted on the major surface 152 of a handle wafer 150 with growth surface 220 facing away from major surface 152, as shown in FIG. 6B. Handle wafer 150 is a wafer of conventional thickness, i.e., about 0.5 mm. In the following description, processes described as being applied to the handle wafer are applied to the handle wafer and all elements currently supported by the handle wafer. Additionally, operations described as being applied to the probe wafer are applied to the probe wafer, the cantilever elements defined in the probe wafer and all layers currently supported by the probe wafer.

In an embodiment, handle wafer 150 is a wafer of single-crystal silicon and the probe wafer is temporarily attached to the handle wafer using clips (not shown). Alternative handle wafer materials include ceramics, sapphire and other suitable materials. In other embodiments, cantilever elements similar to cantilever element 210 are supplied temporarily mounted on a handle wafer.

The cantilever element is covered with sacrificial material leaving at least part of the growth surface exposed. In the example shown, a sacrificial layer 260 of sacrificial material is deposited on the probe wafer with a nominal thickness greater than the distance from handle wafer surface 152 to growth surface 220 so that the sacrificial layer initially covers growth surface 220, as shown in FIG. 6C. A portion of the sacrificial material constituting sacrificial layer 260 is then removed to form a window 264 that exposes at least part of growth surface 220, as shown in FIG. 6D.

In an embodiment, the sacrificial material of sacrificial layer 260 was photoresist. The photoresist was deposited on the probe wafer by spin coating to cover cantilever element 210. The viscosity of the sacrificial material and the spin speed were set to obtain a nominal layer thickness sufficient to cover growth surface with a layer having a nominal thickness of about 100 nm.

Other sacrificial materials that are compatible with the subsequently-performed processing and that can be applied in a manner that causes surface 262 to be a planar surface are known in the art and may alternatively be used. As a further alternative, a layer of a material that covers underlying elements conformally may be deposited on the probe wafer with a thickness sufficient to cover growth surface 220 to provide sacrificial layer 260. An example of a conformally-covering material is silicon dioxide (SiO₂) deposited by chemical vapor deposition (CVD).

The portion of the sacrificial material constituting sacrificial layer 260 that is removed to form window 264 is defined by electron beam lithography. Other lithographic techniques such photolithography and nanoimprint lithography are known in the art and may alternatively be used. The size of window 264 determines the size of the catalyst metal (274 in FIG. 6E) deposited on growth surface 220 and, hence, the diameter of the subsequently-grown nanowire. In an embodiment, window 264 was circular and had a diameter in the range from about 5 nm to about 20 nm. In an embodiment in which photoresist used as sacrificial layer 260, the portion removed to form window 264 was removed by subjecting the probe wafer to the appropriate developer. Directional reactive ion etching or another etching technique can be used to remove any residual sacrificial material remaining on growth surface 220 after the growth surface has been exposed.

In an embodiment in which the sacrificial material constituting sacrificial layer 260 was silicon dioxide, the portion removed to form window 264 was removed by subjecting the probe wafer to a wet etch process using dilute hydrofluoric acid (HF) as etchant.

The processing described above with reference to FIGS. 6C and 6D typically leaves growth surface 220 covered by a thin layer of native silicon dioxide that, if left in place, would hinder the epitaxial growth of a nanowire on the growth surface. Accordingly, such native oxide layer is removed by subjecting growth surface 220 to an etchant that dissolves silicon dioxide.

In an embodiment, the layer of native silicon dioxide was removed from growth surface 220 by subjecting the prove wafer to a wet etch process using dilute hydrofluoric acid (HF) as the etchant. In another embodiment, the layer of native silicon dioxide was removed by subjecting the probe wafer to a dry etch process using HF vapor as the etchant.

Catalyst metal suitable for use in a vapor-liquid-solid nanostructure growth process is then deposited on the growth surface. FIG. 6E shows a layer 272 of catalyst metal deposited on the surface 262 of sacrificial layer 260 and on the exposed portion of the growth surface 220 of cantilever element 210. The portion of catalyst metal layer 272 deposited on the exposed portion of growth surface 220 is indicated by the reference numeral 274.

The material of catalyst metal layer 272 is a metal capable of catalytically decomposing a gaseous precursor to release a respective constituent element of the semiconductor material of nanowire 230 (FIG. 3A). Typical catalyst metals include gold (Au), nickel (Ni), palladium (Pd) and titanium (Ti).

In an embodiment, catalyst metal layer 272 is deposited using electron beam evaporation.

In another embodiment, galvanic displacement is used to deposit catalyst metal 274 selectively on the exposed portion of growth surface 220. In this embodiment, an electrical connection is made to cantilever arm 212 via the probe wafer, and the probe wafer is placed in a solution of gold potassium cyanide (AuK(CN)₂) or another suitable electrolyte. A suitable anode is also placed in the electrolyte and a current is passed through the electrolyte between the anode and the probe wafer. The silicon of growth surface 220 acts as a reducing agent and gold is deposited on the exposed portion of the growth surface through a redox mechanism.

In yet another embodiment, a conventional electroplating process or an electroless plating process is used to deposit catalyst metal layer 272. In yet another embodiment, nanoparticles of catalyst metal may be deposited by spin coating or drop coating in a manner similar to that described above with reference to FIG. 5D.

The sacrificial material is then removed leaving the catalyst metal deposited on the growth surface. FIG. 6F shows cantilever element 210 after sacrificial layer 260 (FIG. 6D) has been removed. Removing sacrificial layer 260 removes all the catalyst metal layer 272 located on the surface 262 of the sacrificial layer, but leaves catalyst metal 274 located on the exposed portion of growth surface 220.

In an embodiment, sacrificial layer 260 of photoresist is removed by a lift-off process in which the probe wafer is immersed in acetone ((CH₃)₂CO). Sacrificial layer 260 of silicon dioxide may be removed by subjecting the probe wafer to a wet etch process in which dilute hydrofluoric acid (HF) is used as etchant.

A semiconductor nanowire is then grown extending from the growth surface using the catalyst metal remaining on the growth surface as catalyst. FIGS. 6G and 6H show nanowire 230 being grown extending from growth surface 220 using catalyst metal 274 (FIG. 6F) remaining on the growth surface as catalyst in a vapor-liquid-solid growth process.

In an embodiment, handle wafer 150 is mounted on the susceptor 180 of a chemical vapor deposition (CVD) reactor (not shown) and the susceptor and, hence, the handle wafer probe wafer, are heated to a deposition temperature near the eutectic point of an alloy between catalyst metal 274 and the semiconductor material from which nanowire 230 will be grown. In an embodiment in which catalyst metal 274 was gold and the semiconductor material from which nanowire 230 is grown was silicon, the susceptor was heated to a growth temperature of about 450° C.

A growth pressure is established inside the CVD reactor and a gaseous precursor mixture is passed over the probe wafer. In FIG. 6G, the gaseous precursor mixture is represented by solid arrows, an exemplary one of which is shown at 182. Reference numeral will be used to refer to the gaseous precursor mixture. Gaseous precursor mixture 182 is composed of a substantially inert carrier gas and one or more precursors in a gaseous state, as described above with reference to FIG. 5F.

Further details of the growth of nanowire 230 will now be described with reference to an example in which the semiconductor material of nanowire 230 has a single constituent element, namely, silicon. The description below can readily be applied to the growth of a nanowire whose semiconductor material is a compound semiconductor. Moreover, the precursor and adatoms of the optional dopant will not be mentioned in the following description.

Molecules of the precursor in gaseous precursor mixture 182 that contact catalyst metal 274 are catalytically decomposed by the catalyst metal. Adatoms of the constituent element resulting from the decomposition of the precursor are deposited on the surface 276 of catalyst metal 274. The deposited adatoms mix with catalyst metal 274 to form an alloy, which has a lower melting point than the original catalyst metal. The alloy melts to form a catalyst nanoparticle 270, which is in a molten state.

Catalyst nanoparticle 270 is capable of catalytically decomposing the precursors in precursor mixture 182. Consequently, additional adatoms of the constituent element(s) are deposited on the surface 276 of catalyst nanoparticle 270 and increase the fraction of the constituent element in the alloy until the alloy becomes saturated with the constituent element. Then, further adatoms of the constituent element cause a corresponding number of atoms of the constituent element to be released from catalyst nanoparticle 270 at its surface adjacent growth surface 220. The released atoms grow epitaxially on the growth surface to form a solid nanowire 230 that extends orthogonally from the growth surface.

Further deposition of adatoms of the constituent element on molten catalyst nanoparticle 270 cause the release of additional atoms of the constituent element from the molten catalyst nanoparticle and an increase in the length of nanowire 230, as shown in FIG. 6H. The process of passing gaseous precursor mixture 182 over the probe wafer is continued until nanowire 230 reaches its design length. Molten catalyst nanoparticle 270 remains at the distal end of nanowire 230, remote from growth surface 220, throughout the nanowire growth process.

The process just described causes nanowire 230 to grow with a cross-sectional area that increases towards growth surface 220. Alternatively, precursor mixture 182 may additionally include a gaseous etchant 184 that causes nanowire 230 to grow with a uniform cross-sectional area along its length, as described above with reference to FIG. 5G. Such gaseous etchant may be provided by using a halogenated precursor as one of the gaseous precursors constituting precursor mixture 182.

To make the embodiment shown in FIG. 4, after growth of nanowire 230 is complete, an etch process using an etchant that is selective between the semiconductor material of nanowire 230 and the alloy material of catalyst nanoparticle 270 is performed to remove nanoparticle 270 from the distal end of nanowire 230.

The probe wafer in which the AFM probes including AFM probe 200 have been fabricated is then detached from handle wafer 150. AFM probe 200 is then broken out from the probe wafer and is mounted in a host atomic force microscope.

In an embodiment, the probe wafer including AFM probe 200 is detached from handle wafer 150 by removing the clips (not shown) holding the wafers together.

In the above description, the probe wafer is detached from handle wafer 150 after nanowire 230 has been grown. Alternatively, the probe wafer can be detached from the handle wafer after sacrificial layer 260 has been removed but before nanowire 230 is grown. In this case, the probe wafer is mounted directly on the susceptor 180 (FIG. 6G) of the CVD growth chamber.

In embodiments of the above method in which the probe wafer lacks apertures extending between its major surfaces, the handle wafer referred to above may be unnecessary.

In embodiments of the above method in which the cantilever elements do not constitute part of a probe wafer, such cantilever elements may be mounted on the handle wafer (FIG. 6B) using double-sided adhesive tape. In an example, the double-sided adhesive tape was based on a polyimide film. After the sacrificial layer has been removed, leaving the catalyst metal on the growth surface (FIG. 6F), the cantilever elements are removed from the handle wafer by carefully pulling them off the adhesive tape. The cantilever elements are then placed in appropriately-shaped recesses defined in the susceptor of the CVD growth chamber for the nanowire growth process described above with reference to FIGS. 6G and 6H. Alternatively, the cantilever elements may be mounted on the surface of an uncontoured susceptor using small clips.

AFM probe 100 or AFM probe 200 is used by mounting it as the AFM probe of a host atomic force microscope and using the atomic force microscope to perform measurements and manipulations that need a probe tip with a high aspect ratio. Such measurements and manipulations include, but are limited to, measurements and manipulations performed on living cells, where the high aspect ratio of the probe tip allows penetration deep into the cell without causing the cell membrane to rupture.

This disclosure describes the invention in detail using illustrative embodiments. However, the invention defined by the appended claims is not limited to the precise embodiments described.

We claim:

1. An atomic force microscope (AFM) probe, comprising
a cantilever element comprising a crystalline growth surface at an end thereof; and
a semiconductor nanowire extending substantially orthogonally from the growth surface.

2. The AFM probe of claim 1, additionally comprising a catalyst nanoparticle at an end of the nanowire remote from the growth surface.

3. The AFM probe of claim 1, in which the cantilever element comprises:
a cantilever arm; and
a frusto-pyramidal probe tip base at an end of the cantilever arm, the probe tip base comprising a crystalline end facet at an end thereof remote from the cantilever arm, the end facet providing the growth surface from which the nanowire extends.

4. The AFM probe of claim 3, in which the cantilever element comprises a monolithic single-crystal semiconductor AFM probe.

5. The AFM probe of claim 3, in which the end facet is a (111) crystalline plane.

6. The AFM probe of claim 3, in which the end facet is one of a (100) crystalline plane and a (110) crystalline plane.

7. The AFM probe of claim 3, in which:
the probe tip base comprises single-crystal semiconductor material; and
the end facet is a (111) crystalline plane of the single-crystal semiconductor material.

8. The AFM probe of claim 3, in which:
the probe tip base comprises single-crystal semiconductor material; and
the end facet is one of a (100) crystalline plane and a (110) crystalline plane of the single-crystal semiconductor material.

9. The AFM probe of claim 1, in which:
the cantilever element comprises a cantilever arm, the cantilever arm comprising single-crystal semiconductor material; and
at least part of the semiconductor material provides the growth surface.

10. The AFM probe of claim 9, in which the growth surface is a (111) crystalline plane of the single-crystal semiconductor material.

11. The AFM probe of claim 9, in which the growth surface is one of a (100) crystalline plane and a (110) crystalline plane of the single-crystal semiconductor material.

12. The AFM probe of claim 1, in which the nanowire comprises single-crystal semiconductor material.

13. The AFM probe of claim 12, in which the single-crystal semiconductor material of the nanowire is doped single-crystal semiconductor material.

14. The AFM probe of claim 1, in which the single-crystal semiconductor material of the nanowire is epitaxial with respect to the growth surface.

15. A method of making an atomic force microscope (AFM) probe, the method comprising:
providing a cantilever element comprising a crystalline growth surface at an end thereof;
covering the cantilever element with sacrificial material, leaving at least part of the growth surface exposed;
depositing catalyst metal on the exposed growth surface;
removing the sacrificial material, the removing leaving the catalyst metal on the growth surface; and
growing a semiconductor nanowire extending from the growth surface using the catalyst metal left on the growth surface, the catalyst metal remaining at a distal end of the nanowire remote from the cantilever element during the growing.

16. The method of claim 15, in which covering the cantilever element comprises applying the sacrificial material using a spin-on process.

17. The method of claim 15, in which the removing is performed using a lift-off process.

18. The method of claim 15, in which the growing comprises passing a gaseous precursor mixture over the cantilever element, the gaseous precursor mixture comprising a precursor for a constituent element of the semiconductor.

19. The method of claim 18, in which the growing additionally comprises passing a gaseous etchant over the cantilever element to grow the nanowire with a substantially uniform cross-sectional area along its length.

20. The method of claim 15, in which:
the cantilever element comprises single-crystal semiconductor material;
the growth surface is a (111) crystalline plane of the semiconductor material; and
the growing comprises epitaxially growing the nanowire on the growth surface.

21. The method of claim 15, in which depositing catalyst metal comprises depositing nanoparticles of the catalyst metal on the sacrificial material and the growth surface.

22. The method of claim 21, in which the depositing nanoparticles comprises depositing a colloidal solution of the nanoparticles on the sacrificial material and the growth surface.

23. The method of claim 22, in which the depositing a colloidal solution of the nanoparticles comprises a spin-on process.

24. The method of claim 15, in which the depositing catalyst metal comprises evaporating the catalyst metal.

25. The method of claim 15, in which the depositing catalyst metal comprises a plating process.

26. The method of claim 15, in which:
the cantilever element comprises:
a cantilever arm, and
a frusto-pyramidal probe tip base at an end of the cantilever arm, the probe tip base comprising a crystalline end facet at an end thereof remote from the cantilever arm, the end facet providing the growth surface; and
the covering comprises covering the cantilever element with the sacrificial material with a thickness that leaves the end facet exposed.

27. The method of claim 15, in which:
the cantilever element comprises:
a cantilever arm, and
a frusto-pyramidal probe tip base at an end of the cantilever arm, the probe tip base comprising a crystalline end facet at an end thereof remote from the cantilever arm, the end facet providing the growth surface; and
the covering comprises:
covering the cantilever element with the sacrificial material with a thickness that covers the end facet, and
removing a portion of the sacrificial material to expose at least part of the end facet.

28. The method of claim 15, in which:
the cantilever element comprises a cantilever arm, the cantilever arm comprising single-crystal semiconductor material, at least part of the semiconductor material providing the growth surface; and
the covering comprises:
covering the cantilever arm with the sacrificial material; and
removing a portion of the sacrificial material to expose the growth surface.
